(19) United States
(12) Patent Application Publication
(10) Pub. No.: US 2026/0134506 A1
(43) Pub. Date: May 14, 2026

(54) IMAGE PROCESSING METHOD, IMAGE PROCESSING APPARATUS, AND IMAGE PROCESSING SYSTEM INCLUDING THE SAME

(71) Applicant: SAMSUNG ELECTRONICS CO., LTD., Suwon-si (KR)

(72) Inventors: Changhoon CHOI, Suwon-si (KR); Byeongdae LEE, Suwon-si (KR); Yongmi LEE, Suwon-si (KR); Seungwon CHOI, Suwon-si (KR); Jongseong CHOI, Suwon-si (KR)

(73) Assignee: SAMSUNG ELECTRONICS CO., LTD., Suwon-si (KR)

(21) Appl. No.: 19/353,147

(22) Filed: Oct. 8, 2025

(30) Foreign Application Priority Data
Nov. 11, 2024 (KR) 10-2024-0159359

(51) Int. Cl. G06T 3/4015; G06T 3/4038; G06T 7/90

(52) U.S. Cl. CPC G06T 3/4015; G06T 3/4038; G06T 7/90; G06T 2207/10024

(57) ABSTRACT

An image processing method includes obtaining a padding margin for padding input data, which includes a target pixel group including an edge pixel; setting, based on a color pattern of the input data and the padding margin, a padding method; and generating output data according to the set padding method. The generating the output data includes: copying, and arranging in a first padding region, pixel data of a first selection region, arranged in rows corresponding to the padding margin, among a plurality of rows including the target pixel group and a first adjacent pixel group adjacent to the target pixel group; and flipping or copying, and arranging in a second padding region, pixel data of a second selection region, arranged in columns corresponding to the padding margin, among a plurality of columns including the target pixel group and a second adjacent pixel group adjacent to the target pixel group.

### CROSS-REFERENCE TO RELATED APPLICATION

This application is based on and claims priority under 35 U.S.C. 517 119 to Korean Patent Application No. 10-2024-0159359, filed on Nov. 11, 2024, in the Korean Intellectual Property Office, the disclosure of which is herein incorporated by reference in its entirety.

### BACKGROUND

One or more example embodiments of the disclosure relate to an image processing method, an image processing apparatus, and an image processing system including the same, and more particularly, to an image processing method for processing image data generated from an image sensor including a color filter array, an image processing apparatus, and an image processing system including the same.

An image processor provided in an electronic device, such as a camera or a smartphone, may perform image processing operations, such as changing a data format of image data generated from an image sensor to a data format, such as RGB or YUV, removing noise from the image data, and adjusting a brightness of the image data. Recently, as a demand for high-quality and high-resolution photos and videos increases, a lot of overhead is applied to image processors, which causes inefficient power consumption of image processors and deterioration of quality of photos and videos.

### SUMMARY

One or more example embodiments of the disclosure provide an image processing method capable of providing an image padding method adaptively applied to an arrangement of various color filters and reducing a memory usage for image padding.

In addition, the disclosure is not limited to the mentioned above. The other disclosures may be clearly understood by those skilled in the art.

According to an aspect of an example embodiment of the disclosure, there is provided an image processing method includes obtaining a padding margin for padding input data, the input data including a target pixel group and the target pixel group including an edge pixel; setting, based on a color pattern of the input data and the padding margin, a padding method; and generating output data according to the set padding method, wherein the generating the output data includes: copying pixel data of a first selection region, arranged in rows corresponding to the padding margin, among a plurality of rows including the target pixel group and a first adjacent pixel group adjacent to the target pixel group, and arranging the copied pixel data of the first selection region in a first padding region; and flipping or copying pixel data of a second selection region, arranged in columns corresponding to the padding margin, among a plurality of columns including the target pixel group and a second adjacent pixel group adjacent to the target pixel group, and arranging the flipped or copied pixel data of the second selection region, in a second padding region.

According to an aspect of an example embodiment of the disclosure, there is provided an image processing apparatus including: a signal processing circuit including a first image padding module, wherein the first image padding module is configured to check a color pattern of input data, obtain a padding margin for padding the input data, set a padding method based on the color pattern and the padding margin, and generate output data according to the set padding method, the input data including a target pixel group and the target pixel group including an edge pixel, and wherein the first image padding module is further configured to: copy pixel data of a first selection region, arranged in rows corresponding to the padding margin, among a plurality of rows including the target pixel group and a first adjacent pixel group adjacent to the target pixel group, and arrange the copied pixel data of the first selection region in a first padding region; and flip or copy pixel data of a second selection region, arranged in columns corresponding to the padding margin, among a plurality of columns including the target pixel group and a second adjacent pixel group adjacent to the target pixel group, and arrange the flipped or copied pixel data of the second selection region, in a second padding region.

According to another aspect of the disclosure, there is provided an image processing system including an image sensor including a first image processing module configured to generate image data, wherein the first image processing module is configured to check a color pattern of input data, obtain a padding margin for padding the input data, set a padding method based on the color pattern and the padding margin, and generate output data according to the set padding method, the input data including a target pixel group and the target pixel group including an edge pixel, wherein the first image processing module is further configured to: copy pixel data of a first selection region, arranged in rows corresponding to the padding margin among a plurality of rows including the target pixel group and a first adjacent pixel group adjacent to the target pixel group, and arrange the copied pixel data of the first selection region in a first padding region, and flip or copy pixel data of a second selection region, arranged in columns corresponding to the padding margin among a plurality of columns including a second adjacent pixel group adjacent to the target pixel group, and arrange the flipped or copied pixel data of the second selection region, in a second padding region.

### BRIEF DESCRIPTION OF DRAWINGS

Example embodiments will be more clearly understood from the following detailed description taken in conjunction with the accompanying drawings in which:

FIG. 1 is a block diagram of an image processing system according to an embodiment;

FIG. 2 is a block diagram of an image sensor according to an embodiment;

FIGS. 3A to 3D are diagrams illustrating examples of a color filter array of a pixel array of an image sensor, according to one or more embodiments;

FIG. 4 is a block diagram of an image padding module according to an embodiment;

FIG. 5 is a diagram illustrating output data generated according to an image processing method, according to an embodiment;

FIGS. 6 and 7 are flowcharts of an image processing method according to one or more embodiments;

FIGS. 8A to 8C are diagrams illustrating an image padding method according to one or more embodiments;

FIGS. 9A to 9C are diagrams illustrating an image padding method according to one or more embodiments;

FIGS. 10A to 10D are diagrams illustrating an image padding methods according to one or more embodiments;

FIG. 11 is a flowchart of an image processing method according to an embodiment;

FIGS. 12A to 12C are diagrams illustrating an image padding method according to one or more embodiments;

FIG. 13 is a block diagram of an image processing apparatus according to an embodiment;

FIG. 14 is a block diagram of an image processing system including an image processing apparatus, according to an embodiment; and

FIG. 15 is a circuit diagram of a pixel group included in a pixel array of FIG. 2, according to an embodiment.

### DETAILED DESCRIPTION

Hereinafter, example embodiments are described in detail with reference to the accompanying drawings.

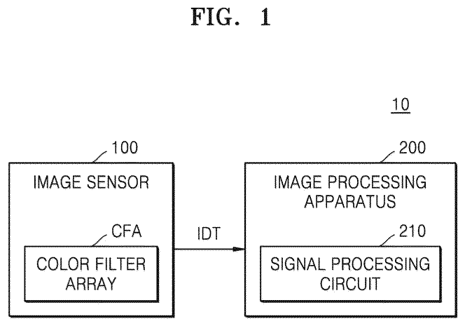

FIG. 1 is a block diagram of an image processing system 10 according to an embodiment.

The image processing system 10 may be implemented as an electronic device configured to capture an image, display the captured image, and/or perform an operation based on the captured image. The image processing system 10 may be implemented as, e.g., a personal computer (PC), an Internet of Things (IoT) device, or a portable electronic device. The portable electronic device may include, for example but not limited to, a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book, a wearable device, and the like. In addition, the image processing system 10 may be mounted on an electronic device, such as a drone or an advanced driver-assistance system (ADAS), or an electronic device provided as a component in a vehicle, furniture, a manufacturing facility, a door, various measurement devices, or the like.

Referring to FIG. 1, the image processing system 10 may include an image sensor 100 and an image processing apparatus 200. The image processing system 10 may further include other components, such as a display, a user interface, and the like. The image processing apparatus 200 may include a signal processing circuit 210. The image processing apparatus 200 or the image processing system 10 may be implemented as a system on chip (SoC). In an embodiment, the image processing system 10 or the image processing apparatus 200 may include an application processor (AP). For example, the signal processing circuit 210 of the image processing apparatus 20 may include the AP.

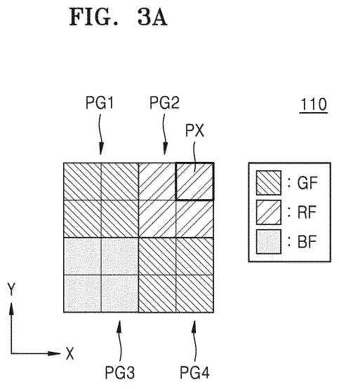

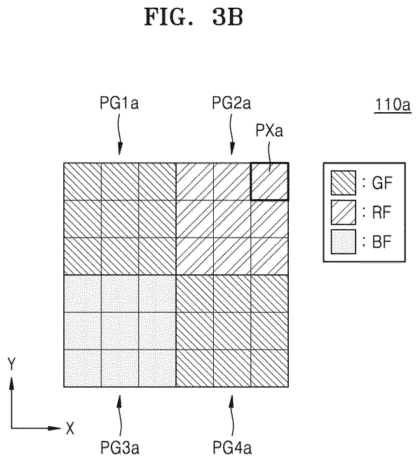

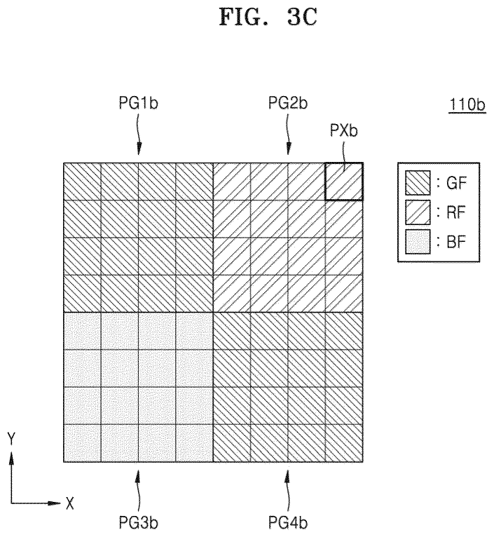

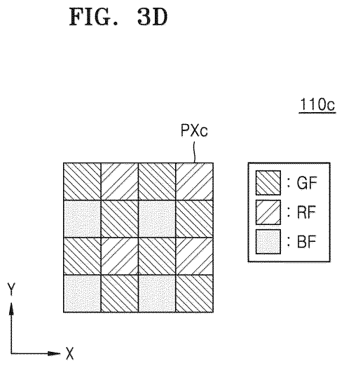

The image sensor 100 may convert an optical signal reflected from an object through an optical lens into an electrical signal and may generate and output image data IDT based on the electrical signal. The image sensor 100 may include a color filter array CFA having a certain pattern and may convert the optical signal into the electrical signal by using the color filter array CFA. In an embodiment, the color filter array CFA may be implemented to support next-generation pixel technologies, such as a tetra pattern, a nona pattern, or a hexadeca pattern as well as a Bayer pattern. Examples of an arrangement pattern of the color filter array CFA may be described below with reference to FIGS. 3A to 3D.

Although only one image sensor 100 is shown in FIG. 1, the image processing system 10 may include a plurality of image sensors 100. The plurality of image sensors 100 may include color filter arrays CFA of different color patterns. The color patterns of the image data IDT respectively output from the plurality of image sensors may be the same or may be different from each other.

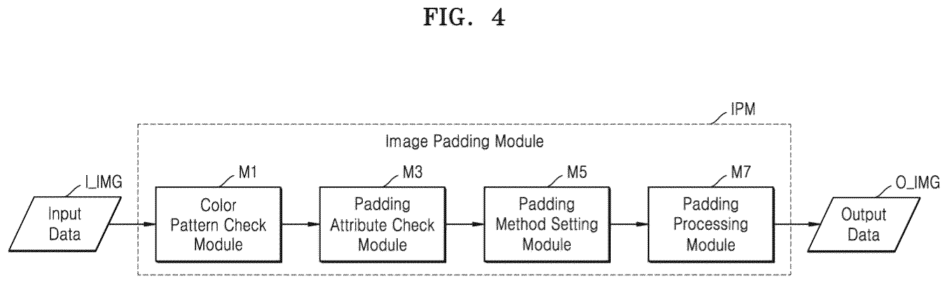

In an embodiment, the signal processing circuit 210 of the image processing apparatus 200 may perform image padding to perform data processing on the image data IDT. For example, the signal processing circuit 210 may include an image padding module (e.g., IPM of FIG. 4), wherein the image padding module IPM may check a color pattern of input data input to the image padding module IPM, check a padding margin required for padding, select a padding method based on the color pattern and the padding margin, and perform padding to generate output data. The image processing apparatus 200 may improve image processing performance for image-padded output data and reduce a memory usage for image padding by adaptively determining an image padding method based on a color filter arrangement of the color filter array CFA.

In addition, the signal processing circuit 210 of the image processing apparatus 200 may further perform an image processing operation, including a remosaic processing operation and/or a demosaic processing operation, on the image data IDT received from the image sensor 100. The signal processing circuit 210 may convert the format of the image data IDT by performing the image processing operation. The signal processing circuit 210 may convert the image data IDT corresponding to a color filter pattern, such as a Bayer pattern, a tetra pattern, or a hexadeca pattern, into full color image data in an RGB format. In an embodiment, the signal processing circuit 210 of the image processing apparatus 200 may perform image padding before performing the image processing operation, such as the remosaic processing operation and/or the demosaic processing operation, thereby enabling image processing on data generated by an edge pixel of the image data IDT.

In addition, the signal processing circuit 210 of the image processing apparatus 200 may perform image signal processing for improving image quality, such as auto dark level compensation (ADLC), bad pixel correction, lens shading correction, gamma correction, color filter array interpolation, color matrix, color correction, and/or color enhancement, in addition to converting the format of the image data IDT into full color image data. The signal processing circuit 210 of the image processing apparatus 200 may perform image padding before performing the image signal processing for improving image quality.

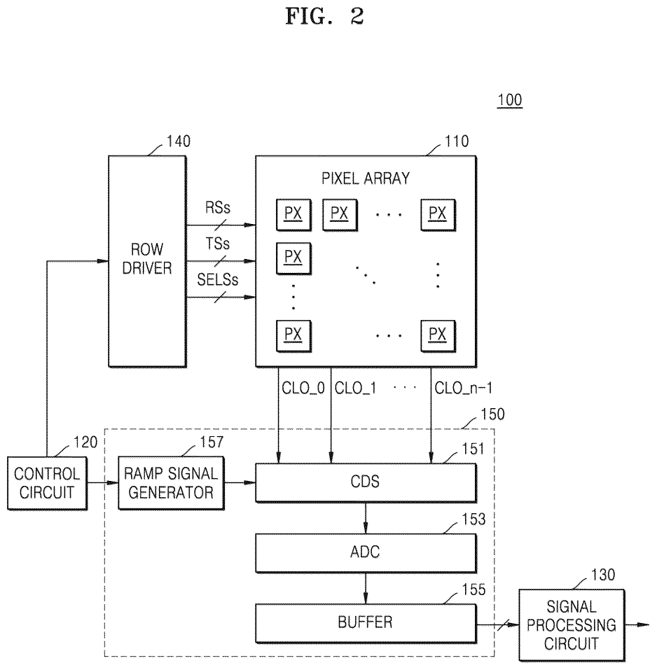

FIG. 2 is a block diagram of the image sensor 100 according to an embodiment.

Referring to FIG. 2, the image sensor 100 may include a pixel array 110, a control circuit 120, a signal processing circuit 130, a row driver 140, and a readout circuit 150. The readout circuit 150 may include a correlated double sampler (hereinafter, referred to as CDS) 151, an analog-digital converter (hereinafter, referred to as ADC) 153, and a buffer 155.

The pixel array 110 may convert an optical signal into an electrical signal and may include a plurality of pixels PX arranged two-dimensionally. The plurality of pixels PX may each generate pixel signals according to a sensed intensity of light. The pixels PX may be implemented as photoelectric converters, such as charge-coupled devices (CCD) or complementary metal oxide semiconductors (CMOSs), and may also be implemented as other various types of photoelectric converters.

The pixel array 110 may include a color filter to sense various colors. Each of the plurality of pixels PX may sense a corresponding color. For example, the color filter array (e.g., CFA of FIG. 1) of the pixel array 110 may have a Bayer pattern or may have a tetra pattern (N=2), a nona pattern (N=3), or a hexadeca pattern (N=4) in which a red color filter, a green color filter, and a blue color filter are arranged in an N×N matrix. Alternatively, for example, the pixel array 110 may include at least one of a white color filter, a yellow color filter, a cyan color filter, and a magenta color filter. Examples of the arrangement of the color filter array CFA may be described in detail below with reference to FIGS. 3A to 3D.

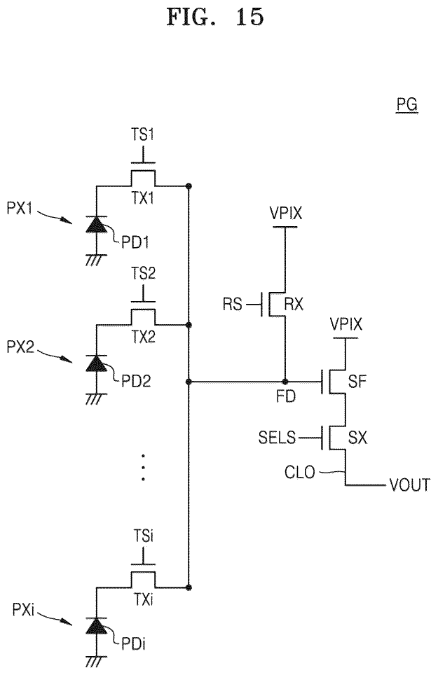

The plurality of pixels PX may output pixel signals to the CDS 151 through corresponding first to n^{th} column output lines CLO_0 to CLO_n-1, respectively. The CDS 151 may sample and hold the pixel signals provided by the pixel array 110. The CDS 151 may double-sample a level of specific noise and a level corresponding to the pixel signals and may output a level corresponding to the difference therebetween. In addition, the CDS 151 may receive ramp signals generated by a ramp signal generator 157, compare the ramp signals with each other, and output a comparison result. An example of a circuit configuration of the plurality of pixels PX will be described below with reference to FIG. 15.

The ADC 153 may convert analog signals corresponding to a level received from the CDS 151 into digital signals. The buffer 155 may latch the digital signals, wherein the latched digital signals may be sequentially output to the signal processing circuit 130 or image data may be output to an outside of the image sensor 100.

The control circuit 120 may control the row driver 140 such that the pixel array 110 absorbs light to accumulate electric charge, temporarily stores the accumulated electric charge, and outputs an electric signal corresponding to the stored electric charge to an outside of the pixel array 110. In addition, the control circuit 120 may control the readout circuit 150 to measure a level of the pixel signals provided by the pixel array 110.

The row driver 140 may generate signals RSs, TSs, and SELSs for controlling the pixel array 110 and may provide the signals RSs, TSs, and SELSs to the plurality of pixels PX. The row driver 140 may determine activation timings and deactivation timings for reset control signals RSs, transfer control signals TSs, and selection signals SELSs provided to the pixels PX.

The signal processing circuit 130 may perform signal processing on signals output from the buffer 155. For example, the signal processing circuit 130 may perform an image processing operation, including a remosaic processing operation, on data received from the readout circuit 150 and may perform image padding before performing the image processing operation. By performing the image processing operation, the signal processing circuit 130 may convert a format of the data received from the readout circuit 150 and may output image data in the converted format to the outside of the image sensor 100. For example, the signal processing circuit 130 may convert image data corresponding to a color filter pattern, such as a tetra pattern, a nona pattern, or a hexadeca pattern, into image data of a Bayer pattern.

In an embodiment, the signal processing circuit 130 may perform signal processing, such as noise reduction, gain adjustment, waveform shaping, interpolation processing, white balance, gamma processing, edge enhancement, and/or the like. The signal processing circuit 130 may perform image padding before performing the signal processing operation.

However, in an embodiment, the signal processing circuit 130 may be provided in a processor (e.g., a processor included in the image processing apparatus 200 of FIG. 1) outside the image sensor 100. Operations of the signal processing circuit 130 may be performed in the image processing apparatus 200.

FIGS. 3A to 3D are diagrams of a part of the pixel array 110 in FIG. 2 to illustrate the color filter array CFA of the pixel array 110 of the image sensor 100, according to one or more embodiments.

Referring to FIG. 3A, the pixel array 110 may include a plurality of pixel groups, for example, first to fourth pixel groups PG1 to PG4. The first pixel group PG1 and the second pixel group PG2 may be arranged in an X-axis direction, and the third pixel group PG3 and the fourth pixel group PG4 may be arranged in the X-axis direction. The first pixel group PG1 and the third pixel group PG3 may be arranged in a Y-axis direction, and the second pixel group PG2 and the fourth pixel group PG4 may be arranged in the Y-axis direction.

Each of the first to fourth pixel groups PG1 to PG4 may include 4 pixels PX in a 2×2 matrix, arranged in two adjacent rows and two adjacent columns. Each of the first to fourth pixel groups PG1 to PG4 may include a color filter to sense various colors, wherein pixels PX included in one pixel group may include the same color filter. In an embodiment, each of the first to fourth pixel groups PG1 to PG4 may include one of a green color filter GF, a red color filter RF, and a blue color filter BF.

Each of the first to fourth pixel groups PG1 to PG4 may include a color filter to correspond to a Bayer pattern. For example, the first pixel group PG1 and the fourth pixel group PG4 may include the green color filter GF, the second pixel group PG2 may include the red color filter RF, and the third pixel group PG3 may include the blue color filter BF. However, the disclosure is not limited thereto. Each of the first to fourth pixel groups PG1 to PG4 may include at least one of a white color filter, a yellow color filter, a cyan color filter, and a magenta color filter. The white color filter may include a color filter capable of transmitting all light of red color, blue color, and green color.

The pixel array 110 of FIG. 3A may be referred to as including a color filter array of a tetra pattern (4×4) because 4 pixels PX form one pixel group and each pixel group includes a corresponding color filter. An image sensor including the pixel array 110 of FIG. 3A may generate image data corresponding to the color filter array of the tetra-pattern.

Referring to FIG. 3B, a pixel array 110a may include a plurality of pixel groups, for example, first to fourth pixel groups PG1a to PG4a. Each of the first to fourth pixel groups PG1a to PG4a may include 9 pixels PXa in a 3×3 matrix, arranged in three adjacent rows and three adjacent columns. Each of the first to fourth pixel groups PG1a to PG4a may include a corresponding color filter, wherein the pixels PXa included in one pixel group may include the same color filter. In an embodiment, each of the first to fourth pixel groups PG1a to PG4a may include one of a green color filter GF, a red color filter RF, and a blue color filter BF.

Each of the first to fourth pixel groups PG1a to PG4a may include a color filter to correspond to a Bayer pattern. For example, the first pixel group PG1a and the fourth pixel group PG4a may include the green color filter GF, the second pixel group PG2a may include the red color filter RF, and the third pixel group PG3a may include the blue color filter BF. However, the disclosure is not limited thereto.

The pixel array 110a of FIG. 3B may be referred to as including a color filter array of a nona pattern (3×3) because 9 pixels PXa form one pixel group and each pixel group includes a corresponding color filter. An image sensor including the pixel array 110a of FIG. 3B may generate image data corresponding to the color filter array of the nona pattern.

Referring to FIG. 3C, a pixel array 110b may include a plurality of pixel groups, for example, first to fourth pixel groups PG1b to PG4b. Each of the first to fourth pixel groups PG1b to PG4b may include 16 pixels PXb in a 4×4 matrix, arranged in four adjacent rows and four adjacent columns. Each of the first to fourth pixel groups PG1b to PG4b may include a corresponding color filter, wherein the pixels PXb included in one pixel group may include the same color filter. In an embodiment, each of the first to fourth pixel groups PG1b to PG4b may include one of a green color filter GF, a red color filter RF, and a blue color filter BF.

Each of the first to fourth pixel groups PG1b to PG4b may include a color filter to correspond to a Bayer pattern. For example, the first pixel group PG1b and the fourth pixel group PG4b may include the green color filter GF, the second pixel group PG2b may include the red color filter RF, and the third pixel group PG3b may include the blue color filter BF. However, the disclosure is not limited thereto.

The pixel array 110b of FIG. 3C may be referred to as including a color filter array of a hexadeca pattern (4×4) because 16 pixels PXb form one pixel group and each pixel group includes a corresponding color filter. An image sensor including the pixel array 110b of FIG. 3C may generate image data corresponding to the color filter array of the hexadeca pattern.

Referring to FIG. 3D, a pixel array 110c may include a color filter array of a Bayer pattern (1×1). The pixel array 110c may include a plurality of pixels PXc including corresponding color filters from among a red color filter RF, a green color filter GF, and a blue color filter BF, wherein adjacent pixels PXc from among the plurality of the pixels PXc may include different color filters.

Referring to FIGS. 3A to 3D, the pixel arrays 110, 110a, 110b, and 110c may include a plurality of microlenses. In an embodiment, one microlens may be disposed on each of the first to fourth pixel groups PG1 to PG4, PG1a to PG4a, and PG1b to PG4b. Alternatively, in an embodiment, one microlens may be disposed on each of the plurality of pixels PX, PXa, PXb, and PXc.

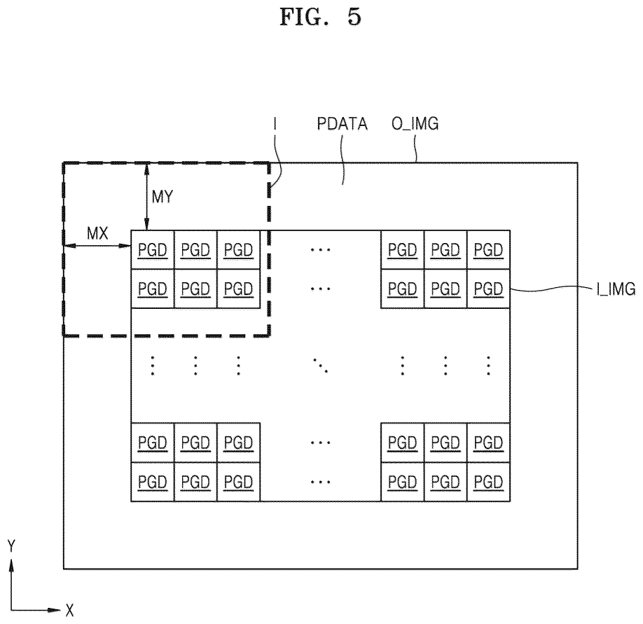

FIG. 4 is a block diagram of an image padding module IPM according to an embodiment. FIG. 5 is a diagram illustrating output data generated according to an image processing method, according to an embodiment. The image padding module IPM of FIG. 4 may be included in the signal processing circuit 210 of the image processing apparatus 200 in FIG. 1 and/or may be included in the signal processing circuit 130 of the image sensor 100 of FIG. 2.

Referring to FIGS. 4 and 5, the image padding module IPM may receive input data I_IMG and generate output data O_IMG. The image padding module IPM may generate padding data PDATA through image padding. By arranging the padding data PDATA in a padding region, the output data O_IMG to which the padding data PDATA is added may be generated from the input data I_IMG.

Since an edge region of the input data I_IMG, in particular, pixel data arranged at an edge of the input data I_IMG, has a limitation in using a neighboring pixel data during image processing, the image processing after image padding may be efficiently performed by generating the output data O_IMG through image padding.

The input data I_IMG may include pixel group data PGD generated in each of the plurality of pixel groups. For example, as described above with reference to FIGS. 3A to 3D, each of the plurality of pixel groups may include pixels arranged in a 2×2 matrix (tetra pattern), pixels arranged in a 3×3 matrix (nona pattern), pixels arranged in a 4×4 matrix (hexadeca pattern), or one pixel arranged in a 1×1 matrix (Bayer pattern).

The image padding module IPM may include a color pattern check module M1, a padding attribute check module M3, a padding method setting module M5, and a padding processing module M7. However, the configuration of the image padding module IPM is an example. It is to be understood that an operation performed by each of the modules M1 to M7 included in the image padding module IPM may be performed by the image padding module IPM. The configuration of the image padding module IPM and each of the modules described below may be implemented as a software block executed by a certain processor or a combination of a dedicated hardware block and a processing unit.

The color pattern check module M1 may check a color pattern of the input data I_IMG. For example, the color pattern of the input data I_IMG may include a Bayer pattern, a tetra pattern, a nona pattern, or a hexadeca pattern. For example, the input data I_IMG may include pixel group data PGD corresponding to a plurality of pixel groups each including pixels arranged in an N×N matrix. An operation of checking the color pattern of the image padding module IPM may refer to checking a value of N.

The padding attribute check module M3 may obtain a padding margin for image padding of the input data I_IMG. The padding margin may include a first padding margin MX in the X-axis direction and a second padding margin MY in the Y-axis direction. The padding margin may be determined according to the image processing operation to be performed on the output data O_IMG. For example, when a specific filter is to be applied to the output data O_IMG, a padding margin may be determined according to a size of the specific filter.

The padding method setting module M5 may set a padding method based on the color pattern and the padding margin. For example, the padding method may be set to generate padding data PDATA by copying or flipping data of a selection region that is a partial region of the input data I_IMG. Based on the edge pixel arranged at the edge (or edge region) of the pixel array (e.g., 110 in FIG. 2), the selection region in the input data I_IMG may be determined considering a memory usage of a memory in which the padding data PDATA is stored and continuity between a plurality of pieces of adjacent pixel data included in the input data 1_IMG. It may be determined whether to copy and arrange the data of the determined selection region in the padding region or to flip and arrange the data of the determined selection region in the padding region. Therefore, the padding method setting module M5 may check the color pattern and the padding attribute to set a suitable padding method which may minimize the memory usage without damaging the color pattern of the input data I_IMG. To this end, different image padding methods (e.g., copying a selection region or flipping a selection region) may be used for a column direction and a row direction.

The padding processing module M7 may perform padding according to the selected padding method and generate the output data O_IMG. When a size of the input data I_IMG is defined as W(Width)×H(Height), and a padding margin in the X-axis direction is MX, and a padding margin in the Y-axis direction is MY, a width of the output data O_IMG may be W+2MX, a height of the output data O_IMG may be H+2MY, and a size of the output data O_IMG may be (W+2MX)×(H+2MY). A starting point of the input data I_IMG in the output data O_IMG may be MX+(MY×(W+2MX)).

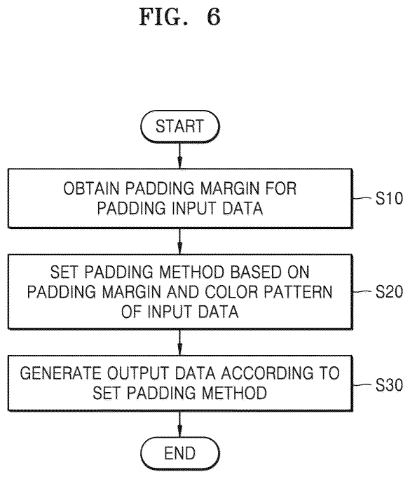

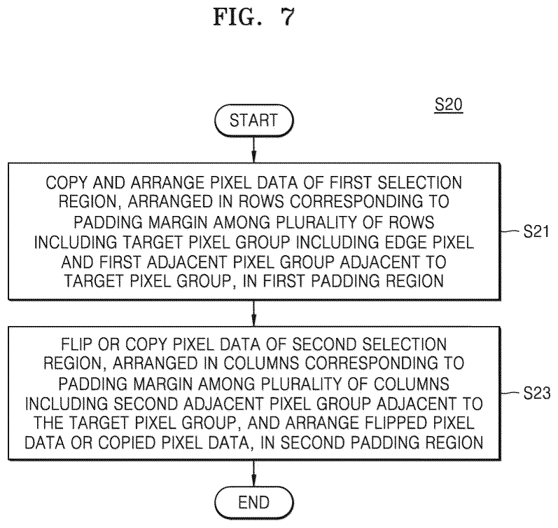

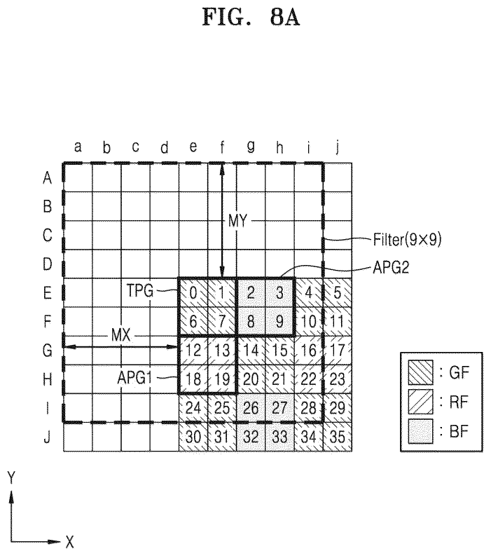

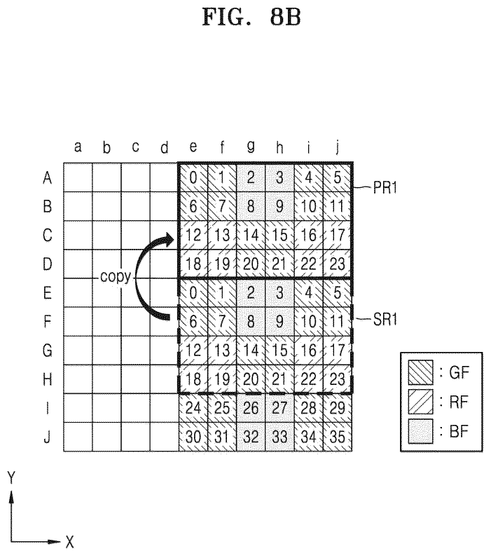

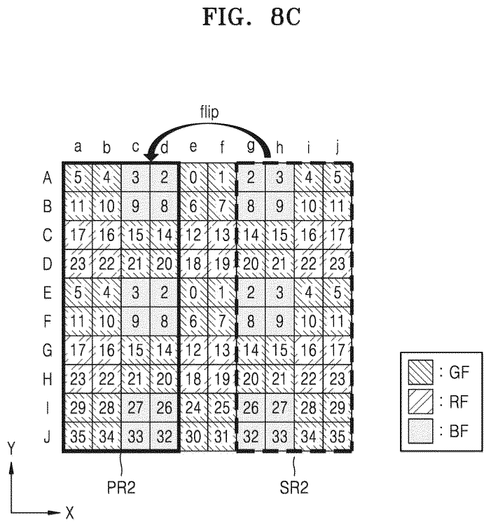

FIGS. 6 and 7 are flowcharts of an image processing method according to one or more embodiments. FIGS. 8A to 8C are diagrams illustrating an image padding method according to one or more embodiments. FIGS. 8A to 8C illustrate enlarged views of region I on an upper left of the output data O_IMG of FIG. 5. The description of FIGS. 8A and 8C may be similarly applied to a lower left, an upper right, and a lower right of the output data O_IMG of FIG. 5.

The image processing method described with reference to FIGS. 6 and 7 may include an image padding method of padding input data to generate output data, wherein the image padding method may be performed by the image padding module IPM in FIG. 4. Thus, the image padding method described with reference to FIGS. 6 and 7 may be performed by the signal processing circuit 210 of the image processing apparatus 200 in FIG. 1 or may be performed by the signal processing circuit 130 of the image sensor 100 in FIG. 2.

Referring to FIG. 6 and FIG. 8A, in operation S10, a padding margin for padding of input data may be obtained. For example, the input data may include pixel data (0 to 35). The first padding margin MX in the X-axis direction and the second padding margin MY in the Y-axis direction may be obtained. The padding margin may be determined according to the size of the filter to be applied to the output data generated according to the image padding. For example, as shown in FIG. 8A, the size of the filter to be applied may be in a 9×9 matrix. Thus, the first padding margin MX may be obtained as 4 and the second padding margin MY may be obtained as 4.

In operation S20, a padding method may be set based on the padding margin and the color pattern of the input data. The color pattern of the input data may include a Bayer pattern, a tetra pattern, a nona pattern, or a hexadeca pattern. For example, as shown in FIG. 8A, the color pattern of the output data may include the tetra pattern (N=2). In operation S30, image padding may be performed according to the set padding method to generate output data.

Referring to FIGS. 7, 8A, and 8B, since the size of the filter to be applied to the input data is in a 9×9 matrix, each of the first padding margin MX and the second padding margin MY may be obtained as 4 based on the edge pixel (pixel data (0)). Thus, padding data from row A to row D may be generated and padding data from column a to column d may be generated.

Operation S20 may include operation S21 and operation S23. In operation S21, a first selection region SR1 arranged in rows (e.g., from row E to row H) corresponding to a padding margin (e.g., the second padding margin MY of 4) may be determined among a plurality of rows including a target pixel group TPG including the edge pixel and a first adjacent pixel group APG1 adjacent to the target pixel group TPG, and pixel data of the first selection region SR1 may be copied and arranged in a first padding region PR1. The first padding region PR1 may include a region adjacent to the input data in the Y-axis direction.

In the disclosure, since the pixel data of the first selection region SR1 is copied and arranged in the first padding region PR1, a required memory usage may be reduced, compared to a comparative example in which pixel data from row G to row J is flipped and arranged in the first padding region PR1. That is, in an example embodiment of the disclosure, since the pixel data in row J is unnecessary in the image padding, use of memory line buffers for the pixel data in row J may be saved, thereby reducing the memory usage for the image padding.

In the disclosure, even when padding data is generated through the image padding, the color pattern of the input data may be maintained while minimizing the memory usage for the padding data. Therefore, resource consumption of the image processing apparatus and the image processing system may be reduced.

Referring to FIGS. 7, 8B, and 8C, in operation S23, a second selection region SR2 arranged in columns (e.g., from column g to column j,) corresponding to the padding margin (e.g., 4) may be determined among a plurality of columns including a second adjacent pixel group APG2 adjacent to the target pixel group TPG, and pixel data of the second selection region SR2 may be flipped and arranged in a second padding region PR2. That is, a number of columns (e.g., 4) corresponding to the padding margin (e.g., 4) may be selected from among the plurality of columns arranged from the second adjacent pixel group APG2 in a direction away from the target pixel group TPG. The pixel data in the second selection region SR2 arranged from the selected column g to column j may be flipped and the flipped pixel data may be arranged in the second padding region PR2. The second padding region PR2 may include a region adjacent to the input data and the first padding region PR1 in the X-axis direction.

However, unlike shown in FIG. 8C, in operation S23, the second selection region arranged in columns (e.g., from column e to column h) corresponding to the padding margin may be determined among the plurality of columns including target pixel group TPG and the second adjacent pixel group APG2 adjacent to the target pixel group TPG, and the pixel data of the second selection region may be copied and arranged in the second padding region PR2. That is, the number of columns (which is 4) corresponding to the padding margin may be selected from among the plurality of columns including the target pixel group TPG and the second adjacent pixel group APG2. The pixel data of the selection region arranged from the selected column e to column h may be copied and arranged in the second padding region PR2.

Since the image padding operation, according to the disclosure, includes copying and/or flipping the pixel data included in the input data, a pixel data at a position before being copied and/or flipped may be used in image padding, and unnecessary calculation may be reduced when the disclosure is implemented substantially in hardware. In addition, it is possible to perform image padding while maintaining a special color pattern even in a tetra pattern, a nona pattern, or a hexadeca pattern that is not a general Bayer pattern.

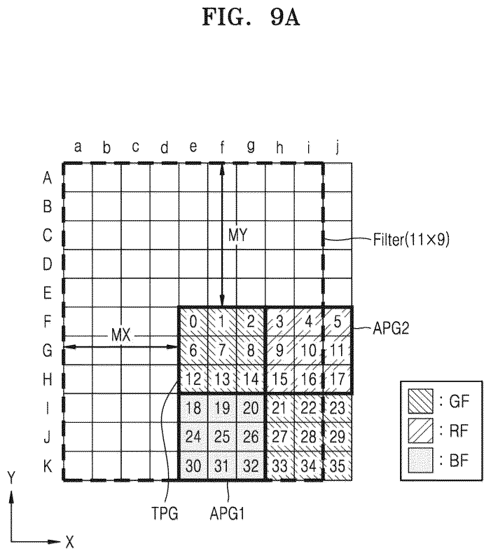

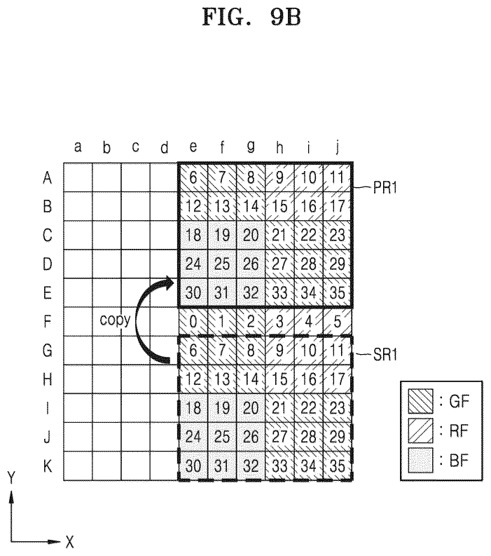

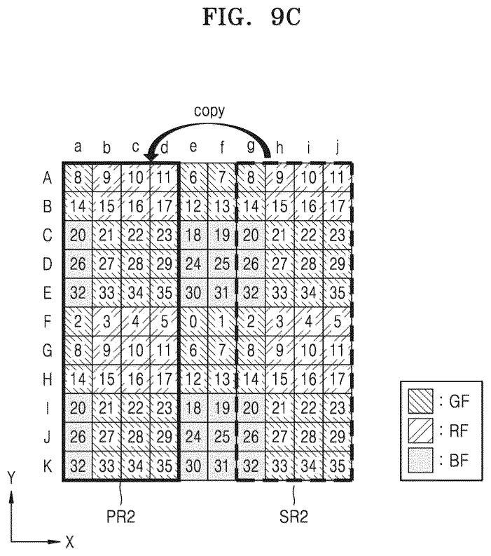

FIGS. 9A to 9C are diagrams illustrating an image padding method according to one or more embodiments.

Referring to FIGS. 9A and 9B, a first padding margin MX in the X-axis direction and a second padding margin MY in the Y-axis direction for padding input data (0 to 35) may be obtained. The first padding margin MX and the second padding margin MY may be determined according to the size of the filter to be applied to the output data generated according to the image padding. For example, as shown in FIG. 9A, the size of the filter to be applied may be in an 11×9 matrix. Thus, the first padding margin MX and the second padding margin MY may be obtained as different values of 4 and 5, respectively, based on the edge pixel (pixel data (0)) of the input data. Accordingly, padding data from row A to row E may be generated and padding data from column a to column d may be generated. The color pattern of the input data may include e.g., the nona pattern (N=3).

A first selection region SR1 arranged in rows (e.g., from row G to row K) corresponding to a padding margin (e.g., the second padding margin MY) may be determined among a plurality of rows including a target pixel group TPG including the edge pixel and a first adjacent pixel group APG1 adjacent to the target pixel group TPG, and pixel data of the first selection region SR1 may be copied, wherein the copied pixel data may be arranged in a first padding region PR1. The first padding region PR1 may include a region adjacent to the input data in the Y-axis direction.

In the disclosure, since the pixel data of the first selection region SR1 may be copied and arranged in the first padding region PR1, the color pattern of the input data may be maintained while minimizing the memory usage for the padding data even when the padding data is generated through the image padding. Therefore, resource consumption of the image processing apparatus and the image processing system may be reduced.

Referring to FIGS. 9B and 9C, a second selection region SR2 arranged in columns (e.g., from column g to column j) corresponding to the padding margin (e.g., the first padding margin MX) may be determined among a plurality of columns including the second adjacent pixel group APG2 adjacent to the target pixel group TPG, and pixel data of the second selection region SR2 may be copied and arranged in a second padding region PR2. The second padding region PR2 may include a region adjacent to the input data and the first padding region PR1 in the X-axis direction. However, unlike shown in FIG. 9C, pixel data of the selection region arranged in columns (e.g., from column h to column j) corresponding to the padding margin among a plurality of columns including the second adjacent pixel group APG2, may be flipped and arranged from column b to column d of the second padding region PR2. The pixel data arranged in the column adjacent to column i in the X-axis direction may be arranged in column a.

Since the image padding, according to the disclosure, includes copying and/or flipping the pixel data included in the input data, the pixel data at the position before being copied and/or flipped may be used for image padding and unnecessary calculation may be reduced when the disclosure is implemented substantially in hardware. In addition, it is possible to perform image padding while maintaining a special color pattern even in a tetra pattern, a nona pattern, or a hexadeca pattern that is not a general Bayer pattern.

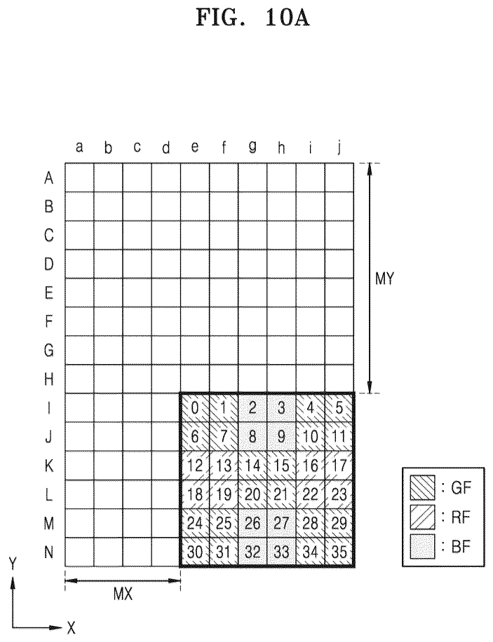

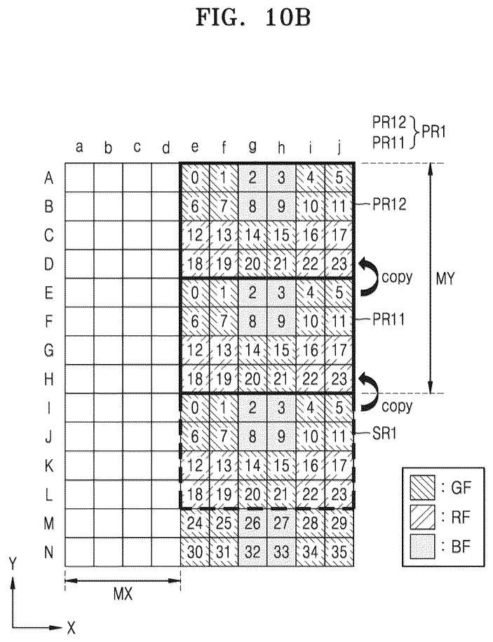

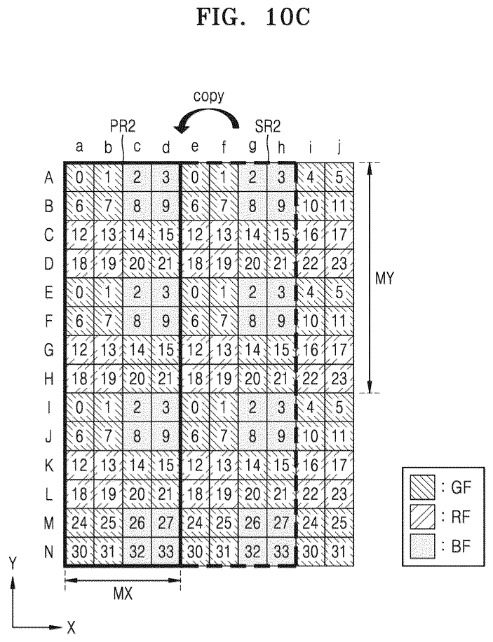

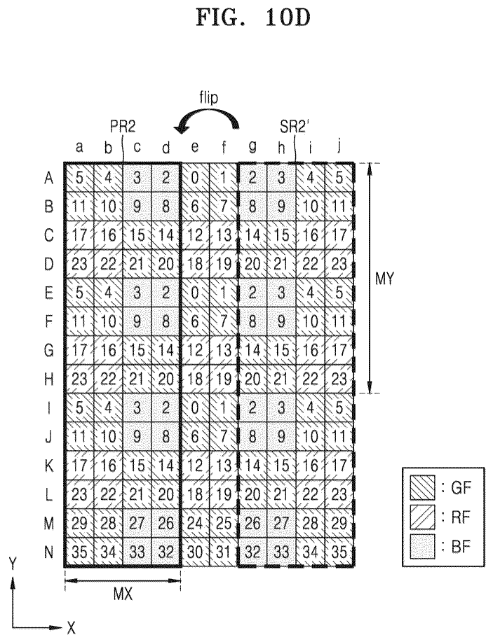

FIGS. 10A to 10D are diagrams illustrating an image padding method according to one or more embodiments.

Referring to FIGS. 10A and 10B, a first padding margin MX in the X-axis direction and a second padding margin MY in the Y-axis direction for padding the input data (0 to 35) may be obtained. For example, the first padding margin MX and the second padding margin MY may be determined to have different values of 4 and 8, respectively. Accordingly, padding data from row A to row H, corresponding to the second padding margin MY, may be generated and padding data from column a to column d, corresponding to the first padding margin MX, may be generated. The color pattern of the input data may include, for example, the tetra pattern (N=2).

Pixel data of a first selection region SR1 arranged in rows (e.g., from row I to row L) corresponding to the second padding margin MY, among a plurality of rows including the target pixel group including the edge pixel (pixel data (0)) and the first adjacent pixel group adjacent to the target pixel group in the Y-axis direction, may be copied multiple times and arranged in a first padding region PR1. For example, the first padding region PR1 may include a first region PR11 from row E to row H and a second region PR12 from row A to row D. The pixel data of the first selection region SR1 may be copied and arranged in the first region PR11 and arranged in the second region PR12.

Referring to FIGS. 10B and 10C, pixel data of a second selection region SR2 arranged in columns (e.g., from column e to column h) corresponding to the first padding margin MX, among a plurality of columns including the target pixel group and the second adjacent pixel group adjacent to the target pixel group in the X-axis direction, may be copied and arranged in the second padding region PR2.

Referring to FIGS. 10B and 10D, pixel data of a second selection region SR2′ arranged in columns (e.g., from column g to column j) corresponding to the first padding margin MX, among a plurality of columns including the target pixel group and the second adjacent pixel group adjacent to the target pixel group in the X-axis direction may be flipped and arranged in the second padding region PR2.

When the pixel data of the second selection region SR2 is copied and arranged in the second padding region PR2 as illustrated in FIG. 10C, the padding data may be generated using a relatively small amount of memory while maintaining the color pattern when generating the padding data. On the other hand, as shown in FIG. 10D, when the pixel data of the second selection region SR2′ is flipped and arranged in the second padding region PR2, the memory usage relatively increases. However, the image padding method according to FIG. 10D may be advantageous in terms of continuity between data. Accordingly, the image processing apparatus (e.g., 200 of FIG. 1) according to the disclosure or the image processing system including the same may generate padding data by flipping or copying pixel data considering characteristics of image padding.

However, the image padding method according to the disclosure is not limited thereto. The image padding may be performed by a combination of flipping and copying of pixel data. For example, the padding data may be arranged by flipping, in a padding region relatively close to the target pixel group including the edge pixel or the padding data may be arranged by copying, in a padding region relatively far from the target pixel group.

In an embodiment, when the size of the first padding margin MX or the second padding margin MY is greater than a repetition cycle in which the color pattern of the input data (0 to 35) is repeated, the pixel data of the second selection region SR2 or the first selection region SR1 may be copied multiple times and arranged in the second padding region PR2 or the first padding region PR1. According to an example of the color pattern illustrated in FIG. 10A, since the color pattern is repeated in units of four rows and the color pattern is repeated in units of four columns, the second padding margin MY may be greater than the repetition cycle (which is 4). Therefore, in the disclosure, the pixel data of the first selection region SR1 may be copied multiple times and arranged in the first padding region PR1. In this way, even when the padding data is generated by the image padding, the color pattern of the input data may be maintained while reducing the memory usage for the padding data.

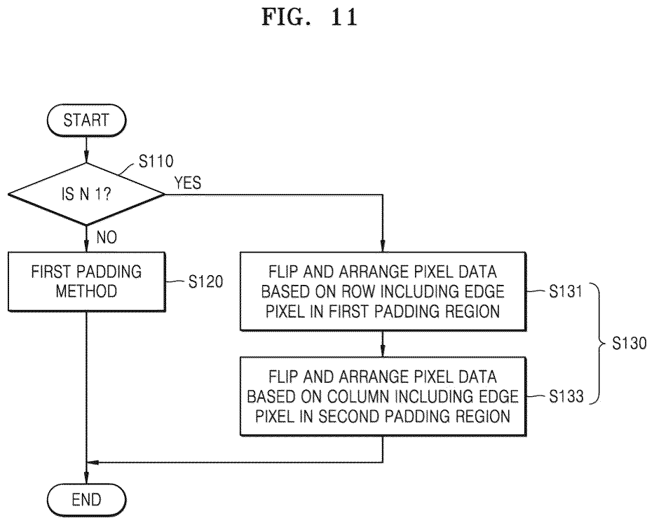

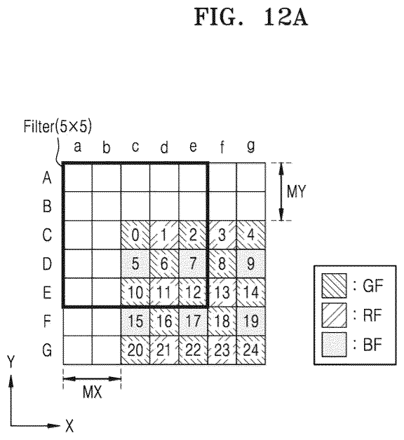

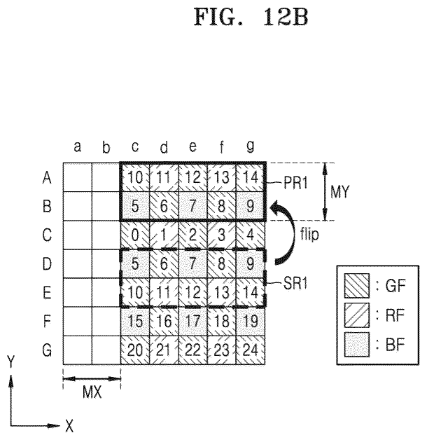

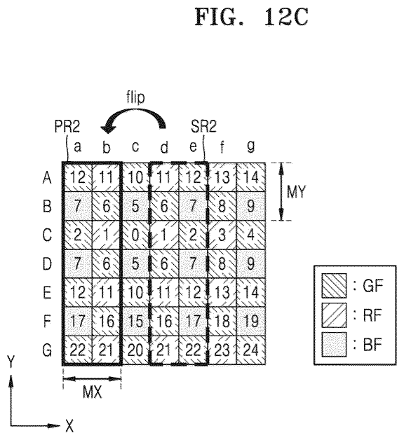

FIG. 11 is a flowchart of an image processing method according to an embodiment. FIGS. 12A to 12C are diagrams illustrating an image padding method according to one or more embodiments.

The image processing method described with reference to FIG. 11 may include an image padding method to generate output data through image padding, wherein the image padding method may be performed by the image padding module IPM in FIG. 4. Thus, the image padding method described with reference to FIGS. 6 and 7 may be performed by the signal processing circuit 210 of the image processing apparatus 200 in FIG. 1 or may be performed by the signal processing circuit 130 of the image sensor 100 in FIG. 2.

Referring to FIG. 11, the image processing method according to the disclosure may check a color pattern of input data and may check whether the color pattern of the input data is arranged to include the same color in units of an N×N matrix. In operation S110, it may be checked whether N is 1, for example, a Bayer pattern. When N is not 1 (NO in S110), for example, when N is 2 (tetra pattern), N is 3 (nona pattern), or N is 4 (hexadeca pattern), a first padding method may be performed in operation S120. Operation S20 in FIG. 7 may be performed according to the first padding method.

When N is 1 (YES in S110), a second padding method may be performed in operation S130. That is, when pixel data generated by adjacent pixels in the input data includes information about different colors, the second padding method may be performed. For example, when the color pattern of the input data is a Bayer pattern, the second padding method (S130) may be performed. Operation S130 may include operation S131 and operation S133.

Referring to FIGS. 11, 12A, and 12B, the color pattern of the input data (0 to 24) may include a Bayer pattern with N=1. In operation S131, the pixel data may be flipped based on a row (e.g., row C) including the edge pixel (input data (0)), and may be arranged in the first padding region PR1.

For example, the first padding margin MX in the X-axis direction and the second padding margin MY in the Y-axis direction for padding the input data (0 to 24) may each be obtained as 2. The first padding margin MX and the second padding margin MY may be determined according to the size of the filter to be applied to the output data generated according to the image padding. For example, as shown in FIG. 12A, the size of the filter to be applied may correspond to a 5×5 matrix. According to the second padding margin MY, row D and row E may be selected as the first selection region SR1 and the pixel data in the first selection region SR1 may be flipped. Thus, the flipped pixel data from the pixel data in row D and row E may be arranged in row A and row B in the first padding region PR1.

Referring to FIGS. 11, 12B, and 12C, in operation S133, pixel data may be flipped, based on a column (e.g., column c) including the edge pixel (pixel data 0), and may be arranged in the second padding region PR2. For example, according to the first padding margin MX, column d and column e may be selected as the second selection region SR2 and the pixel data of the second selection region SR2 may be flipped. Thus, the flipped pixel data from the pixel data in column d and column e may be arranged in the second padding region PR2.

Compared to the first padding method S120, the second padding method S130 may flip and arrange the pixel data included in the input data (0 to 24) in the first padding region PR1 and the second padding region PR2 without copying the pixel data. When pixels are arranged such that the color sensed by each pixel is different and pixel data is generated accordingly, the memory usage required for copying and arranging the pixel data as padding data may be the same as the memory usage required for flipping and arranging the pixel data as padding data. Therefore, in the image processing method according to the disclosure, when N has a value of 1, pixel data included in the input data (0 to 24) may be flipped without being copied and arranged in the first padding region PR1 and the second padding region PR2, in consideration of continuity of pixel data.

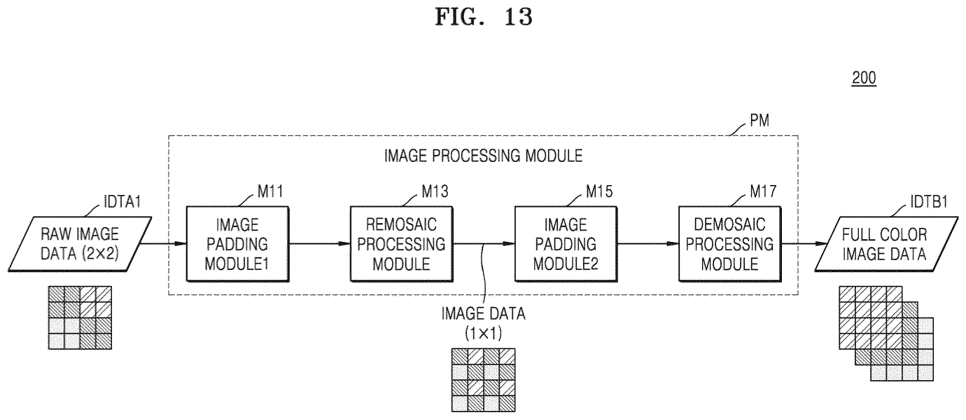

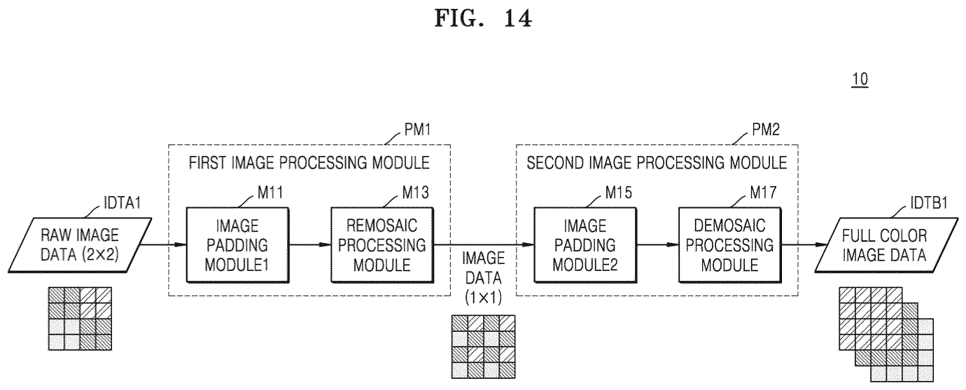

FIG. 13 is a block diagram of the image processing apparatus 200 according to an embodiment. FIG. 14 is a block diagram of the image processing system 10 including the image processing apparatus 200, according to an embodiment. An image processing module PM of FIG. 13 may be included in the signal processing circuit 210 of the image processing apparatus 200 in FIG. 1. The configuration of the image processing module PM and modules described below may be implemented as a software block executed by a certain processor or a combination of a dedicated hardware block and a processing unit.

Referring to FIG. 13, the image processing module PM may generate a plurality of pieces of full color image data IDTB1 by performing image processing on raw image data IDTA1. In an embodiment, the raw image data IDTA1 may include image data of a color pattern in an N×N matrix that is not a Bayer pattern and may include, e.g., image data of a tetra pattern that is a color pattern in a 2×2 matrix. That is, the raw image data IDTA1 may include pixels in which one pixel group is arranged in an N×N matrix, wherein each pixel group may include pixel data for a corresponding one of a red color, a green color, and a blue color.

The raw image data IDTA1 may have a color pattern based on the color pattern of the color filter array (e.g., CFA of FIG. 1) of the image sensor (e.g., 100 of FIG. 1). Alternatively, the raw image data IDTA1 may have a color pattern different from that of the color filter array CFA of the image sensor 100 as image data generated according to another image processing.

The image processing module PM may include a first image padding module M11, a remosaic processing module M13, a second image padding module M15, and a demosaic processing module M17. Each of the first image padding module M11 and the second image padding module M15 may include the image padding module IPM described with reference to FIG. 4 and may perform the image processing methods described with reference to FIGS. 5, 6, and 11.

The first image padding module M11 may perform the image padding for image processing of the remosaic processing module M13. In an embodiment, the first image padding module M11 may perform image padding according to the first padding method S120 in FIG. 11. The remosaic processing module M13 may remosaic output data output from the first image padding module M11 to generate image data of a Bayer pattern. For example, the remosaic processing module M13 may perform tetra-demosaicing, which is color interpolation for converting image data of a tetra pattern into image data of the Bayer pattern (i.e., a 1×1 color pattern). Thus, the image padding may be required for generating neighboring pixel data of the edge pixel for color interpolation of the edge pixel data of the image data prior to performing the remosaicing.

The second image padding module M15 may perform the image padding for image processing of the demosaic processing module M17. For example, the second image padding module M15 may generate padding image data by padding the image data of the Bayer pattern. In an embodiment, the second image padding module M15 may perform image padding according to the second padding method S130 in FIG. 11.

The demosaic processing module M17 may demosaic the padding image data generated from the second image padding module M15 to generate a plurality of pieces of full color image data IDTB1. For example, the demosaic processing module M17 may perform color interpolation to convert the image data of the Bayer pattern into the plurality of pieces of full color image data IDTB1. Thus, the image padding may be required for generating neighboring pixel data of the edge pixel for color interpolation of the edge pixel data of the image data prior to performing the demosaicing. In an embodiment, the plurality of pieces of full color image data IDTB1 may include red image data of a red color, green image data of a green color, and blue image data of a blue color.

Operations of the remosaic processing module M13 and the demosaic processing module M17 illustrated in FIG. 13 are examples of image processing that requires image padding. In addition, the image padding may be required for preprocessing other image processing(s).

Referring to FIG. 14, a first image processing module PM1 may include a first image padding module M11 and a remosaic processing module M13, and a second image processing module PM2 may include a second image padding module M15 and a demosaic processing module M17. In an embodiment, the first image processing module PM1 may be included in the signal processing circuit 130 of the image sensor 100 in FIG. 2, and the second image processing module PM2 may be included in the signal processing circuit 210 of the image processing apparatus 200 in FIG. 1.

FIG. 15 is a circuit diagram of a pixel group PG included in the pixel array of FIG. 2, according to an embodiment. The pixel group PG of FIG. 15 may correspond to any one of the first to fourth pixel groups PG1 to PG4, PG1a to PG4a, and PG1b to PG4b described with reference to FIG. 3A to FIG. 3C.

Referring to FIG. 15, the pixel group PG may include a plurality of pixels PX1 to PXi including the same color filter. In an embodiment, the plurality of pixels PX1 to PXi included in one pixel group PG may share a floating diffusion region FD and may share a reset transistor RX, a source follower SF, and a selection transistor SX. However, in the circuit diagram of the pixel group PG shown in FIG. 15, each of the plurality of pixels PX1 to PXi may individually include the floating diffusion region FD or only some of the plurality of the pixels PX1 and PXi may share the floating diffusion region FD.

Each of the plurality of pixels PX1 to PXi may include a corresponding photodetector (one of PD1 to PDi) and a corresponding transfer transistor (one of TX1 to TXi). Each of the photodetectors PD1 to PDi may generate a photocharge that varies with the intensity of light. For example, each of the photodetectors PD1 to PDi may include a P-N junction diode and may generate a charge in proportion to the amount of incident light, that is, electrons having a negative charge and holes having a positive charge. Each of the photodetectors PD1 to PDi may include at least one of a phototransistor, a photogate, a pinned photodiode (PPD), and a combination thereof, as an example of the photoelectric converter.

Each of the transfer transistors TX1 to TXi may transfer the generated photocharge to the floating diffusion region FD, according to corresponding transfer control signals TS1 to TSi (e.g., TSs in FIG. 2). When each of the transfer transistors TX1 to TXi is turned on, the photocharge generated by each of the photodetectors PD1 to PD4 included in the pixel group PG may be transmitted to one floating diffusion region FD and may be accumulated and stored in the floating diffusion region FD.

The reset transistor RX may periodically reset the charges accumulated in the floating diffusion region FD. A drain of the reset transistor RX may be connected to the floating diffusion region FD and a source thereof may be connected to a power supply voltage VPIX. When the reset transistor RX is turned on according to the reset control signals (e.g., RSs in FIG. 2), the charges accumulated in the floating diffusion region FD may be discharged to reset the floating diffusion region FD.

The source follower SF may be controlled according to the amount of photocharges accumulated in the floating diffusion region FD. The source follower SF may buffer the signals, according to the charges charged in the floating diffusion region FD, as a buffer amplifier. The source follower SF may amplify a potential change in the floating diffusion region FD and output the amplified potential change to a column output line (CLO, e.g., one of CLO_0 to CLO_n−1 in FIG. 2) as a pixel signal VOUT. The selection transistor SX may output the pixel signal VOUT to the CDS (e.g., 151 in FIG. 2) through a column output line CLO, in response to the selection signals e.g., SELSs in FIG. 2.

While the disclosure has been particularly shown and described with reference to example embodiments thereof, it will be understood that various changes in form and details may be made therein without departing from the spirit and scope of the following claims and their equivalents.

What is claimed is:

1. An image processing method comprising:
obtaining a padding margin for padding input data, the input data comprising a target pixel group and the target pixel group comprising an edge pixel;
setting, based on a color pattern of the input data and the padding margin, a padding method; and
generating output data according to the set padding method, wherein the generating the output data comprises:
copying pixel data of a first selection region, arranged in rows corresponding to the padding margin, among a plurality of rows comprising the target pixel group and a first adjacent pixel group adjacent to the target pixel group, and arranging the copied pixel data of the first selection region in a first padding region; and
flipping or copying pixel data of a second selection region, arranged in columns corresponding to the padding margin, among a plurality of columns comprising the target pixel group and a second adjacent pixel group adjacent to the target pixel group, and arranging the flipped or copied pixel data of the second selection region, in a second padding region.

2. The image processing method of claim 1, wherein the flipping or copying the pixel data of the second selection region and arranging the flipped or copied pixel data of the second selection region, in the second padding region comprises:
selecting a number of columns corresponding to the padding margin from among a plurality of columns arranged from the second adjacent pixel group in a direction away from the target pixel group; and
flipping pixel data of the second selection region, arranged in the selected number of columns, and arranging the flipped pixel data of the second selection region in the second padding region.

3. The image processing method of claim 1, wherein the flipping or copying the pixel data of the second selection region and arranging the flipped or copied pixel data of the second selection region, in the second padding region comprises:
selecting a number of columns corresponding to the padding margin from among the plurality of columns comprising the target pixel group and the second adjacent pixel group; and
copying pixel data of the second selection region, arranged in the selected number of columns, and arranging the copied pixel data of the second selection region in the second padding region.

4. The image processing method of claim 1, wherein each of the target pixel group, the first adjacent pixel group, and the second adjacent pixel group comprises a plurality of pixels adjacent to each other and generating pixel data for a same color.

5. The image processing method of claim 4, wherein each of the target pixel group, the first adjacent pixel group, and the second adjacent pixel group comprises a plurality of pixels arranged in an N×N matrix pattern, where N is one of 2, 3, and 4.

6. The image processing method of claim 1, wherein the copying the pixel data of the first selection region and arranging the copied pixel data of the first selection region in the first padding region comprises copying pixel data of the first selection region multiple times and arranging the pixel data copied multiple times in the first padding region.

7. The image processing method of claim 1, wherein the color pattern of the input data comprises a Bayer pattern,
wherein the generating the output data comprises:
flipping pixel data based on a row comprising the edge pixel and arranging the flipped pixel data in the first padding region; and
flipping pixel data based on a column comprising the edge pixel and arranging the flipped pixel data in the second padding region.

8. The image processing method of claim 1, wherein the obtaining the padding margin comprises obtaining the padding margin based on a size of a filter used in data processing to be performed on the output data.

9. The image processing method of claim 1, wherein the obtaining the padding margin comprises obtaining a first margin in a row direction and a second margin in a column direction.

10. An image processing apparatus comprising:
a signal processing circuit comprising a first image padding module,
wherein the first image padding module is configured to check a color pattern of input data, obtain a padding margin for padding the input data, set a padding method based on the color pattern and the padding margin, and generate output data according to the set padding method, the input data comprising a target pixel group and the target pixel group comprising an edge pixel, and
wherein the first image padding module is further configured to:
copy pixel data of a first selection region, arranged in rows corresponding to the padding margin, among a plurality of rows comprising the target pixel group and a first adjacent pixel group adjacent to the target pixel group, and arrange the copied pixel data of the first selection region in a first padding region; and
flip or copy pixel data of a second selection region, arranged in columns corresponding to the padding margin, among a plurality of columns comprising the target pixel group and a second adjacent pixel group adjacent to the target pixel group, and arrange the flipped or copied pixel data of the second selection region, in a second padding region.

11. The image processing apparatus of claim 10, wherein the signal processing circuit further comprises:
a remosaic processing module configured to remosaic the output data and generate image data of a Bayer pattern;
a second image padding module configured to pad the image data of the Bayer pattern and generate padding image data; and
a demosaic module configured to demosaic the padding image data and generate a plurality of pieces of full color image data.

12. The image processing apparatus of claim 11, wherein the plurality of pieces of full color image data comprise red color image data, green color image data, and blue color image data.

13. The image processing apparatus of claim 11, wherein each of the target pixel group, the first adjacent pixel group, and the second adjacent pixel group comprises a plurality of pixels arranged in an N×N matrix pattern, where N is one of 2, 3, and 4.

14. The image processing apparatus of claim 11, wherein the second image padding module is further configured to:
flip pixel data based on a row comprising an edge pixel of the image data of the Bayer pattern, and arrange the flipped pixel data in a first padding region of the image data of the Bayer pattern; and
flip pixel data based on a column comprising the edge pixel of the image data of the Bayer pattern, and arrange the flipped pixel data in a second padding region of the image data of the Bayer pattern.

15. The image processing apparatus of claim 10, wherein the first image padding module is further configured to:
select a number of columns corresponding to the padding margin from among a plurality of columns arranged from the second adjacent pixel group in a direction away from the target pixel group; and
flip pixel data of the second selection region arranged in the selected number of columns and arrange the flipped pixel data of second selection region in the second padding region.

16. The image processing apparatus of claim 10, wherein the first image padding module is further configured to:
select a number of columns corresponding to the padding margin from among the plurality of columns comprising the target pixel group and the second adjacent pixel group; and
copy pixel data of the second selection region arranged in the selected number of columns and arrange the copied pixel data of the second selection region in the second padding region.

17. The image processing apparatus of claim 10, wherein the first image padding module is further configured to copy pixel data of the first selection region multiple times and arrange the pixel data copied multiple times in the first padding region.

18. The image processing apparatus of claim 10, wherein pixel data generated by adjacent pixels, in the input data, comprises information about different colors, and
wherein the first image padding module is further configured to flip pixel data based on a row comprising the edge pixel, arrange the flipped pixel data in the first padding region, flip pixel data based on a column comprising the edge pixel, and arrange the flipped pixel data in the second padding region.

19. An image processing system comprising:
an image sensor comprising a first image processing module configured to generate image data,
wherein the first image processing module is configured to check a color pattern of input data, obtain a padding margin for padding the input data, set a padding method based on the color pattern and the padding margin, and generate output data according to the set padding method, the input data comprising a target pixel group and the target pixel group comprising an edge pixel,
wherein the first image processing module is further configured to:
copy pixel data of a first selection region, arranged in rows corresponding to the padding margin among a plurality of rows comprising the target pixel group and a first adjacent pixel group adjacent to the target pixel group, and arrange the copied pixel data of the first selection region in a first padding region, and
flip or copy pixel data of a second selection region, arranged in columns corresponding to the padding margin among a plurality of columns comprising a second adjacent pixel group adjacent to the target pixel group, and arrange the flipped or copied pixel data of the second selection region, in a second padding region.

20. The image processing system of claim 19, wherein the image sensor further comprises a second image processing module configured to perform an image signal processing on the image data,
wherein the first image processing module further comprises a remosaic processing module configured to remosaic the output data and generate the image data, and
wherein the second image processing module comprises a second image padding module configured to generate padding image data by padding the image data, and a demosaic processing module configured to generate a plurality of pieces of full color image data by demosaic the padding image data.
